(19) United States
(12) Patent Application Publication
(10) Pub. No.: US 2020/0282571 A1
(43) Pub. Date: Sep. 10, 2020

(54) GRIPPING DEVICE, SEPARATING DEVICE AND METHOD FOR GRIPPING BODIES, AND USE OF A GRIPPING DEVICE

(71) Applicant: Zahoransky AG, Todtnau (DE)

(72) Inventors: Florian KIEFER, Frohnd (DE); Ingo KUMPF, Schlechtnau (DE); Marc KONIG, Freiburg (DE)

(73) Assignee: Zahoransky AG, Todtnau (DE)

(21) Appl. No.: 16/804,654

(22) Filed: Feb. 28, 2020

(30) Foreign Application Priority Data
Mar. 7, 2019 (DE) 102019105834.1

(51) Int. Cl. B25J 15/00; B25J 15/06

(52) U.S. Cl. CPC B25J 15/0066; B33Y 80/00; B25J 15/0028; B25J 15/0616

(57) ABSTRACT

For handling blanks, semi-finished products or finished products in an automated production processes, a gripping device (3) is provided that has a gripper (4) that is assigned a stripper (5), with the stripper having at least one stripping element (6). The stripping element (6) can be moved as required past the gripper (4) in a stripping movement between a starting position and an end position in order to remove bodies (2) possibly interfering with the gripping process from a gripping region of the gripper (4). This occurs in particular when the gripper (4) has already gripped a body (2) to be gripped.

### INCORPORATION BY REFERENCE

The following documents are incorporated herein by reference as if fully set forth: German Patent Application No. DE 10 2019 105 834.1, filed Mar. 7, 2019.

### TECHNICAL FIELD

The invention relates to gripping devices having at least one gripper for gripping provided bodies, to a separating device having at least one gripping device, to a method for gripping provided bodies and to the use of a gripping device for gripping elongate bodies.

### BACKGROUND

Gripping devices of the type stated at the outset are already known in various embodiments from the prior art. Thus, for instance, Document DE 38 17 465 A1 discloses an apparatus for feeding workpieces for use in robots having at least one optically controlled gripper for removing the workpieces arranged at a depositing location. DE 83 15 322 U1 has already made known an apparatus for mechanically feeding brush bodies to a plugging machine. There is provision in this apparatus that a metering apparatus is connected to a brush body supply and has devices at least for premetering and fine metering of in each case a number of brush bodies. Document DE 25 56 710 A1 discloses an auxiliary apparatus for brush manufacture. The auxiliary apparatus has a receiving container or similar feeding elements for the brush bodies and a removal and transporting device engaging therein. Within the transport path of the brush bodies there is provided at least one position-correcting and/or separating device, downstream of which is arranged at least one discharge station, for example a magazine or a clamping location.

With increasing automation in the production of a wide variety of products, there is an increasing requirement for blanks or semi-finished products, from which the finished products are intended to be produced, or the finished products themselves, to be separated and provided in an ordered manner, for example for machining and/or processing and/or packaging thereof. For this purpose, use is often made of gripping devices of the type stated at the outset that provide the blanks, semi-finished products or products in an automated manner.

Particularly where blanks, semi-finished products or finished products, also simply termed bodies below, are provided in an unordered manner, for example as loose material, difficulties can arise in the automated gripping of the bodies provided in an unordered manner.

### SUMMARY

The object of the invention is therefore to provide gripping devices, a separating device, a method for gripping bodies and the use of a gripping device of the type stated at the outset whereby difficulties in the automated gripping particularly of bodies provided in an unordered manner can be reduced or even avoided.

To achieve this object, first of all a gripping device having one or more features of the gripping device as described herein is provided. Thus, in a gripping device of the type stated at the outset, it is in particular provided to achieve the object that the gripping device has at least one stripper which is assigned to the gripper and which has at least one stripping element, wherein the stripping element can be moved past the gripper in a stripping movement between a starting position and an end position.

Such a gripping device makes it possible for bodies which possibly collide with a body gripped by the gripper or, in the unordered state, potentially even lie on the gripped body to be removed prior to removal of the gripped body and transfer to a downstream processing step.

The gripping device can have a stripper drive for driving the at least one stripping element. This stripper drive allows the at least one stripping element to be moved from its starting position and into its end position and back again in order to carry out the above-described stripping movement. The at least one stripping element can be arranged on the gripping device, in particular on the gripper, so as to be movably mounted. The stripping movement is particularly preferably a pivoting movement. For this purpose, the at least one stripping element can be pivotably mounted.

It is possible to assign a dedicated stripper drive to each stripping element. However, it is also possible to drive a plurality of stripping elements by a common stripper drive. Furthermore, it is possible to couple the at least one stripping element of the gripping device to the at least one gripper in such a way that, upon movement of the gripper, the at least one stripping element is finally also moved in its intended stripping movement. It can be advantageous in this connection if forced coupling and/or forced guidance is provided between the at least one stripping element and the at least one gripper.

In one embodiment, there is provision that a pivot axis of the at least one stripping element is oriented in or parallel to a closing direction of the gripper. Particularly when the gripper is intended to grip elongate bodies, for example brush bodies or toothbrush bodies, the at least one stripping element can be guided, in its stripping movement along a gripped elongate body, past the latter in order to remove possibly interfering further bodies from a gripping region of the gripper. Here, the stripping movement can be oriented transversely or at a right angle to the closing direction or closing movement of the gripper.

The at least one stripping element of the gripping device can consist, for example, of a hard material, of a rigid material, of a flexible material and/or of a combination of materials.

To achieve the object, there is further provided a gripping device of the type stated at the outset that has additional features as described herein. Thus, in a gripping device of the type stated at the outset, it is in particular providsed to achieve the object that the gripper is arranged on a gripper holder of the gripping device so as to remain resiliently, in particular against a feed direction of the gripper towards a body to be gripped. It is possible in this way for damage, in particular to bodies provided in an unordered manner, to be avoided when gripping a body. By virtue of the fact that the gripper is arranged on the gripper holder of the gripping device so as to be resiliently mounted, for example spring-mounted, the gripper can, for example, retreat against its feed direction into its gripping position if there should occur a collision between the gripper and the provided bodies and/or between a body gripped by the gripper and other provided bodies. This allows gentle gripping of the provided bodies and helps avoid damage thereto and possibly also to the gripping device.

The gripping device can further have a gripper holder on which a plurality of grippers are arranged. Here, each of the grippers arranged on a gripper holder of the gripping device can be moved with a dedicated stroke, in particular with a dedicated vertical stroke, preferably independently of the other grippers.

To achieve the object, there is finally also provided another gripping device of the type stated at the outset that has additional features as described herein. Thus, to achieve the object in a gripping device of the type stated at the outset, it is provided in particular that the gripping device, preferably the gripper, has at least one positioning stop which is designed to define on the gripper a desired position of a body to be gripped. The positioning stop makes it possible to increase the accuracy with which the gripper can grip the bodies. Ultimately, this simplifies the automated handling and separation particularly of bodies provided in an unordered manner. Moreover, the positioning stop also makes it possible to avoid damage when gripping bodies. The positioning stop is preferably designed in such a way that a body automatically achieves its desired position on the gripper when the latter grips the body.

In one embodiment of the gripping device, there is provision that it combines at least the features of two of the different features, each directed to a gripping device as noted with one another. In one embodiment of the gripping device, there is provision that it contains all of the features of the gripping devices as described.

The gripper of the above-described gripping devices can have a centring feature, preferably in the form of a cutout and/or in the form of cut-outs which correspond in pairs. The centring feature can be arranged or formed on at least one gripper jaw of the gripper. In a centring device which consists of cut-outs corresponding in pairs, the corresponding cut-outs of a pair can be arranged on mutually assigned gripper jaws of the gripper. The centring device can be used and designed to define a position of a body relative to gripper jaws of the gripper.

Gripper jaws of the gripper of the above-described gripping devices can be 3D-printed. It is possible in this way for the gripper jaws of the gripper also to be provided with an unconventional shape and/or with a shape which can be produced by conventional production methods only with difficulty or not at all.

In one embodiment of the gripping device, there is provision that at least one gripper of the gripping device and/or the aforementioned at least one gripper of the gripping device is a suction gripper. A suction gripper allows even sensitive bodies to be gripped reliably and gently. The suction gripper can comprise at least one sucker. In particular elongate bodies, such as for example toothbrush bodies, can be readily gripped by a suction gripper which comprises at least two suckers.

In one embodiment of the above-described gripping devices, there can be provision that, for resilient mounting of the at least one gripper, the gripping device has at least one guide element and at least one restoring element. The at least one guide element and the at least one restoring element can be arranged between the gripper and a gripper holder, for example the gripper holder already mentioned above. An example of a restoring element which can be used is a spring element, in particular a spring, preferably a compression spring.

One embodiment of the above-described gripping devices has a monitoring sensor, in particular a force sensor. The monitoring sensor makes it possible to monitor an approach movement of the at least one gripper into its gripping position and/or a driving force of a drive of the at least one gripper. An inadmissible increase in force during the approach of the gripper into its gripping position can occur as a result of a collision of the gripper with an obstacle and/or with other provided bodies. It is thus possible for the gripper to be halted if such an inadmissible increase in force has been detected. Damage to the gripping device and also damage to provided bodies can be avoided in this way.

In one embodiment of the above-described gripping devices, the use of software for monitoring an approach movement of the at least one gripper into its gripping position and/or for monitoring a driving force of a drive of the at least one gripper is also provided. It is possible by means of such software for certain operating parameters of the gripping device, which allow a conclusion to be drawn on a collision of the gripping device with an obstacle, to be monitored and for a corresponding counter-measure to be initiated. It is thus possible for example to use the aforementioned software together with the aforementioned monitoring sensor to monitor a driving force and/or a power consumption of a drive of the at least one gripper.

For automated determination and/or identification of gripping points on bodies to be gripped, it may be expedient if the gripping device has a gripping point determination unit. The gripping point determination unit can comprise at least one camera. The operation of the gripping point determination unit can be supported by a body illumination unit of the gripping device.

The gripping device can further have a controller which takes account of and/or specifies process parameters relevant for the gripping of the bodies and/or with which the gripping device can be operated in an automated manner. The aforementioned gripping point determination unit of the gripping device can be connected to the controller. It is possible in this way for data relevant for the gripping of a certain body, which have been determined by the gripping point determination unit, to be transmitted from the latter to the controller of the gripping device. Thus, with consideration of the gripping points identified by the gripping point determination unit, the controller can control the gripper of the gripping device in a targeted manner and thus specify its movements.

The gripping device can additionally have a sensor for checking the presence of a gripped body. Such a sensor makes it possible to monitor whether the gripper has actually properly gripped the body. A comparable check can also appear by determining a length of a closing movement of the gripper. This check can be carried out for example by the controller of the gripping device.

In one embodiment of the gripping device, there is provision that the stripper has at least two stripping elements which are arranged on different sides of the gripper. The stripping elements can cross one another in their starting position and/or be pivotable about spaced-apart, identically oriented and/or parallel pivot axes. Thus, in their stripping movement which they perform on their path between the starting position and the end position, the stripping elements can sweep over as large an area as possible and remove interfering bodies therefrom.

In one embodiment of the gripping device, there is provision that the stripper comprises two pairs of spaced-apart stripping elements. These stripping elements are mounted movably, preferably pivotably, and allow bodies lying on top of or against a gripped body to be removed in a particularly reliable manner. The two pairs of stripping elements can be arranged on different, preferably on opposite, sides of the gripper. The stripping elements of a pair can be pivotable about a common pivot axis.

Here, a distance between the stripping elements of a pair can be greater than a dimension of the gripper that can be measured in the distance direction. It is thus possible for this pair of stripping elements to be guided, in the above-described stripping movement, past the gripper and also past a body gripped by the gripper. Particularly when a distance of a second pair of stripping elements of the stripper from one another is greater than a distance of a first pair of stripping elements from one another, the two pairs of stripping elements can cross one another in their starting position. In this way, each pair of stripping elements, when carrying out its stripping movement, can cover a maximum possible distance and thus remove possibly interfering bodies from the gripped body in a particularly large area.

It can be advantageous here if the stripping elements are pivotable in pairs about in each case a common pivot axis. It is possible in this way to prevent a situation in which the stripping elements of a pair collide with one another when carrying out the stripping movement.

A positioning stop, for example the positioning stop already mentioned above, can be arranged or formed between gripper jaws of the gripper and/or on the gripper.

The gripper can have gripper jaws whose movements are for example guided in a forced manner by means of a slotted guideway. It is also possible to move only one of two mutually assigned gripper jaws of the gripper, while the other is a stationary gripper jaw.

It is also conceivable for the gripping device to comprise a gripper having gripper jaws which are each motor-driven by a corresponding drive.

In one embodiment of the above-described gripping devices, the gripping device can further have at least one robot arm on which the gripper is arranged. In this way, a gripping device is provided which is particularly flexible and can be adapted comparatively simply to a wide variety of gripping tasks. The movements of the robot arm can be controlled for example by the aforementioned controller of the gripping device. Here, the controller can also take account of the information which is collected for example with the aid of the gripping point determination unit.

The aforementioned gripping devices can each have a quick-change device for the at least one gripper and/or can each have a quick-change device for the at least one stripping element. The quick-change devices allow the at least one gripper and/or the at least one stripping element to be interchanged as required even without the use of a tool.

To achieve the object, there is also provided a separating device having one or more features described herein which has at least one gripping device as described herein.

By virtue of the at least one gripping device, the separating device can be used in a particularly flexible and variable manner. It is thus possible, with the separating device, to separate bodies of different shape, colour and geometry without complicated adaptations or structural modifications of the separating device being required.

For the purpose of feeding the bodies to be separated and/or to be gripped, the separating device can have a body-feeding device. The separating device can also comprise a depositing surface for the bodies to be separated and/or to be gripped. The body-feeding device preferably opens at least indirectly onto or into the depositing surface, with the result that the fed bodies necessarily reach the depositing surface.

The separating device can additionally have a vibrating device. This is preferably assigned to the above-described depositing surface. The vibrating device makes it possible already to perform a first separation, which can also be termed preliminary separation, of the bodies often applied to the depositing surface in the form of loose material. The vibrating device can comprise a vibrating belt, for example. The vibrating belt can form at least part of the aforementioned depositing surface of the separating device. The vibrating belt allows a quantity of bodies deposited thereon to be loosened by a vibrating movement of the vibrating belt and thus allows the bodies contained in the quantity to be separated.

The vibrating belt can be provided with protuberances. The protuberances allow a movement of the vibrating belt to be reliably transmitted to bodies deposited thereon. The vibrating belt and/or the aforementioned depositing surface can also have a colour which is tailored to a colour of bodies deposited thereon. In this connection, it can be expedient if the colour of the vibrating belt and/or of the depositing surface has the greatest possible contrast from a colour of the bodies deposited thereon. This can promote optical/visual recognition of the bodies on the vibrating belt and in particular automated identification or determination of gripping points.

In order to promote the optical/visual recognition of bodies on the vibrating belt and/or automated identification or determination of gripping points, it can also be expedient if the vibrating belt and/or the depositing surface are/is transparent and/or light-permeable. The bodies deposited thereon can thus be illuminated from below.

At least part of the aforementioned depositing surface can be formed on a vibrating table. This vibrating table can be part of the aforementioned vibrating device of the separating device and be used to separate and to split apart the bodies deposited thereon to a greater extent as required.

In one embodiment of the aforementioned separating device, a body illumination unit, in particular the aforementioned body illumination unit of the gripping device, can be arranged below the depositing surface. In another embodiment of the aforementioned separating device, a body illumination unit, in particular the aforementioned body illumination unit of the gripping device, can be arranged above the depositing surface.

In a further embodiment of the aforementioned separating device, a body illumination unit is arranged above the depositing surface, and a body illumination unit is arranged below the depositing surface.

The aforementioned body illumination units make it possible for the depositing surface, and especially bodies situated thereon, to be brightly illuminated. This promotes reliable, in particular optical, identification of gripping points which are approached by the gripping device to grip the provided bodies.

It should be mentioned just in passing that, depending on the colour and/or pattern of the bodies to be separated and to be gripped, light of different wavelengths can here be emitted by the body illumination unit or the body illumination units. The aim of this is to simplify the identification of accessible gripping points by means of the gripping point determination unit. It is thus possible to emit light with such a wavelength or colour onto the depositing surface that produces the greatest possible contrast in an image to be evaluated by the gripping point determination unit for identifying accessible gripping points.

The separating device can additionally have a depositing station which is arranged downstream of the gripping device and which has defined body depositing places. This body depositing station can comprise a depositing belt on which the body depositing places are arranged. The depositing belt allows the body depositing places and bodies arranged thereon to be fed for processing in downstream processing steps.

Furthermore, it is possible for the separating device to comprise a handling unit for further transporting the separated bodies. This handling unit can preferably be assigned to the aforementioned depositing station. The handling unit can be used to feed already separated bodies situated within the depositing station to a downstream processing station. For this purpose, the handling unit can have at least one transfer gripper.

To achieve the aforementioned object there is also provided a method of the type stated at the outset for gripping provided bodies. To achieve the aforementioned object, it is thus in particular provided in the method stated at the outset that a gripping point of a body that is accessible for a gripper of the gripping device is identified, whereafter the gripper grips the body at the identified gripping point, whereafter at least one stripping element of a stripper assigned to the gripper is moved past the gripper in a stripping movement between a starting position and an end position in order to remove bodies bearing against the gripped body and/or lying on the gripped body and/or colliding therewith from the gripper and/or from the gripped body.

The method in which the aforementioned separating device and/or the aforementioned gripping devices can be used allows bodies provided in particular in an unordered manner to be gripped more simply and ultimately be separated more simply.

The bodies to be gripped can be elongate bodies. They can have a length-width ratio of at least 3 to 1. In particular, the method is suitable for handling, gripping and/or separating brush bodies, in particular toothbrush bodies.

The bodies to be gripped can preferably be provided as loose material. Here, the bodies to be gripped generally initially form unordered piles. Such bodies whose gripping points are accessible for the gripper can be identified within the piles. As soon as an accessible gripping point has been identified, the gripper can grip the body at this gripping point. Bodies which could hamper free removal of the gripped body from the pile are then removed from the removing region or gripping region by means of the stripper. This can occur in particular by means of the at least one stripping element of the stripper. It is thus possible for bodies lying in particular on the gripped body to be removed reliably by means of the stripper.

The aforementioned gripping point can preferably be optically identified or determined. This can occur by means of a camera and preferably by means of a gripping point determination unit, as has been described above.

Here, the bodies to be gripped, in particular if they are present as loose material in a pile, can at first be separated, in particular when no free accessible gripping point can be identified. After separation, which can be carried out for example by the aforementioned vibrating device, it can be attempted again to identify an accessible gripping point. Where appropriate, this procedure can be repeated until such time as at least one accessible gripping point can be identified.

In order to avoid gripping failures, it can be checked whether a body has been actually gripped by the gripper. This can occur in particular by means of a sensor of the gripping device and/or by determining a length of a closing movement of the gripper.

To achieve the object there is also provided the use of a gripping device for gripping elongate bodies as described herein, in particular for gripping brush bodies and/or toothbrush bodies. The gripping device can here also be used for separating such elongate bodies, in particular for separating brush bodies and/or toothbrush bodies.

### BRIEF DESCRIPTION OF THE DRAWINGS

The invention will now be described in more detail on the basis of an exemplary embodiment, but is not limited to this exemplary embodiment. Further exemplary embodiments will emerge through a combination of the features of individual or multiple claims with one another and/or from a combination of individual or multiple features of the exemplary embodiment. In the drawings illustrated in part in a highly schematic manner:

FIG. 1 shows a perspective view of a separating device for toothbrush bodies that comprises a gripping device with a gripper,

FIG. 2 shows a detail view of the gripper of the gripping device shown in FIG. 1, wherein it can be seen that the gripper holds a toothbrush body gripped between its gripper jaws,

FIG. 3 shows a perspective view of the separating device shown in FIG. 1, where here stripping elements of a stripper, which is assigned to the gripper of the gripping device, are arranged out of their starting position shown in FIGS. 1 and 2 into an intermediate position which they intermittently reach when carrying out their stripping movement on the way into the end position shown in FIGS. 5 and 6,

FIG. 4 shows the gripper shown in FIG. 3 in an enlarged illustration,

FIG. 5 shows a perspective view of the separating device shown in FIGS. 1 and 3, where here the stripping elements of the stripper have attained their end position,

FIG. 6 shows an enlarged view of the gripper shown in FIG. 5,

FIG. 7 shows a perspective view of a further embodiment of a separating device with a gripping device which has a suction gripper as gripper, and

FIG. 8 shows an enlarged view of the gripper shown in FIG. 7.

### DETAILED DESCRIPTION

In the following description of different embodiments of the invention, elements which correspond in their function are given corresponding reference numbers even if they differ in terms of design or configuration.

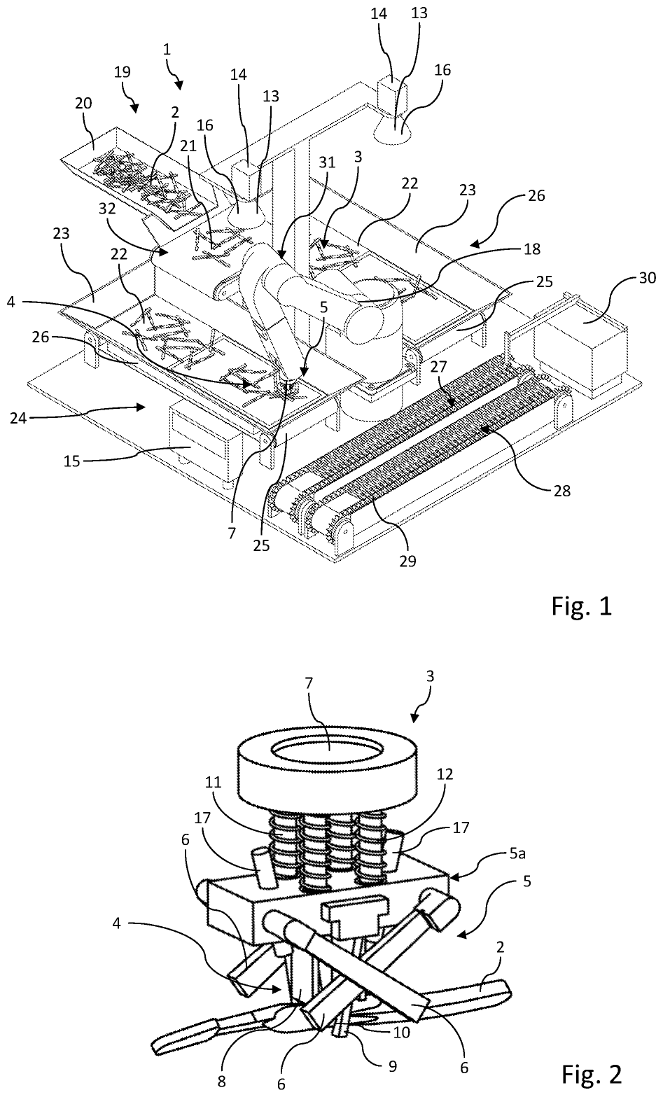

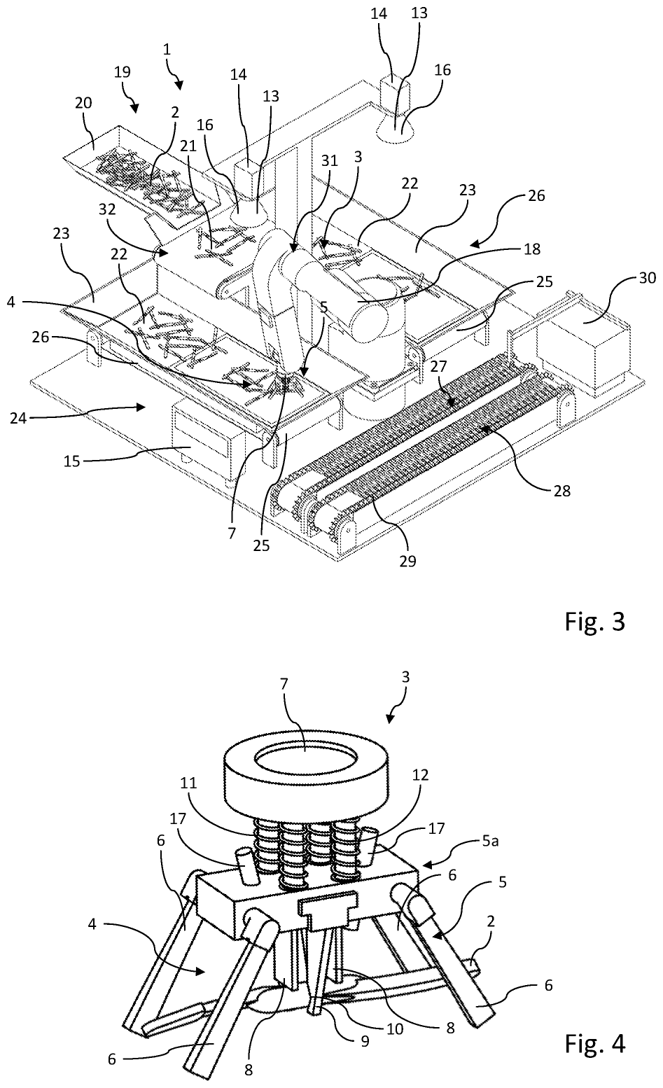

FIGS. 1, 3, 5 and 7 show different embodiments of in each case a separating device designated overall by 1. Without concrete reference to a specific embodiment, the following description can be read on all the embodiments shown in the figures.

FIGS. 1, 3 and 5 show a separating device 1 in different states. The separating device 1 serves to separate bodies 2, here toothbrush bodies 2, fed to the separating device 1 in an unordered manner. For this purpose, the separating device 1 has, inter alia, a gripping device 3. The gripping device 3 allows the toothbrush bodies 2 still situated in an unordered manner to be grasped individually and thus finally be deposited in a separate manner.

The gripping device 3 has a gripper 4. This serves to grip the provided toothbrush bodies 2.

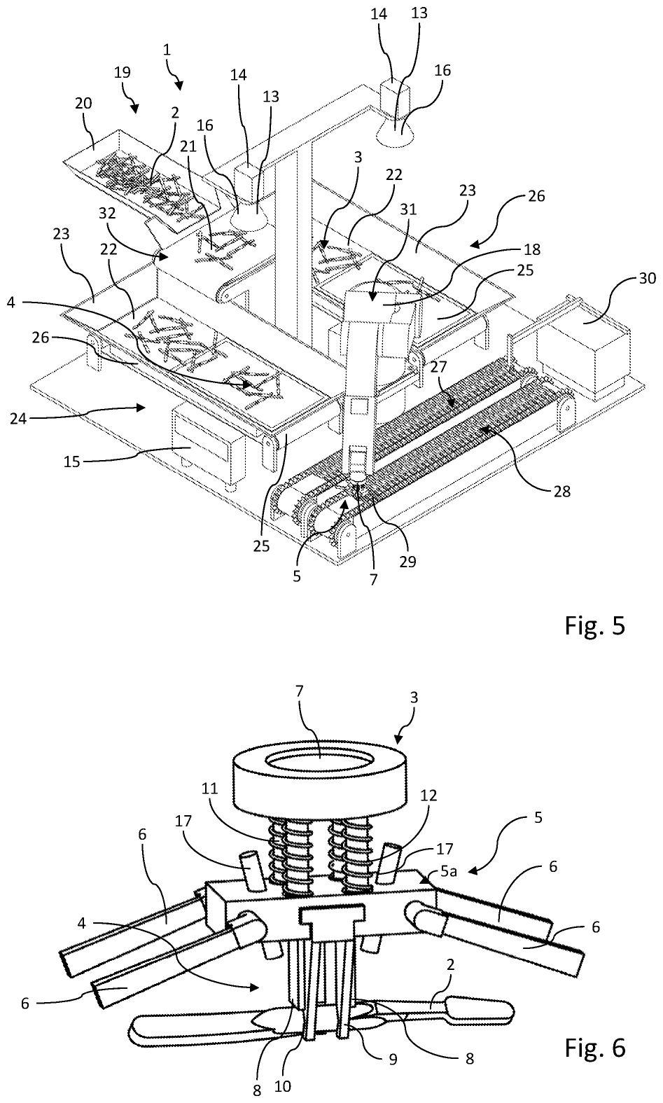

The gripping device 3 comprises a stripper 5 assigned to the gripper 4. The stripper 5 has a total of four stripping elements 6 which, according to the figures, have a finger-shaped design. The stripping elements 6 are moved past the gripper 4 in a stripping movement between a starting position (cf. FIGS. 1 and 2) and an end position (cf. FIGS. 5 and 6). The stripping movement, which is particularly clear from a comparison of FIGS. 2, 4 and 6, allows brush bodies 2 which are situated adjacent to a brush body 2 gripped by the gripper 4 to be removed from the gripped brush body 2 and out of a gripping region of the gripper 4. To drive the stripping element 6, the gripping device 3 has a stripper drive 5a.

FIGS. 2, 4 and 6 further show that the gripper 4 is arranged on a gripper holder 7 of the gripping device 3 resiliently against a feed direction of the gripper 4 in which it is moved in the direction of a depositing surface 22 on which the bodies 2 to be gripped are arranged. The resilient mounting of the gripper 4 on the gripper holder 7 makes it possible to avoid not only damage to the bodies 2 provided for gripping but also damage to the gripper 4. In the event of a collision, the resiliently mounted gripper 4 can retreat against the feed direction of the gripper 4, which ultimately promotes gentle gripping of provided bodies 2, in particular toothbrush bodies 2.

The stripping elements 6 are pivotably mounted on the gripper 4. Here, in each case two of the four stripping elements 6 are arranged on the gripper 4 so as to be mounted pivotably about a common pivot axis. Here, the pivot axes of the stripping elements 6 are arranged at a distance from and parallel to one another and oriented parallel to a closing direction of the gripper 4. The stripping movement which is carried out by the stripping elements 6 is accordingly oriented transversely or at a right angle to the closing direction or closing movement of the gripper 4.

The gripper 4 of the gripping device 3 that is shown in FIGS. 1 to 6 additionally has two positioning stops 8. The positioning stops 8 of the gripper 4 are designed to specify a desired position of a body 2 to be gripped on the gripper 4.

The gripper 4 comprises a plurality of gripper jaws 9 on which centring means 10 in the form of cut-outs 10 corresponding in pairs are provided. The centring means 10, that is to say the pairs of corresponding cut-outs 10, define a position of a gripped toothbrush body 2 relative to the two gripper jaws 9 of the gripper 4. The gripper jaws 9 of the gripper 4 can be 3D-printed.

For resilient mounting of the gripper 4, the gripping device 3 has a total of four guide elements 11 with in each case a restoring element 12 which are arranged between the gripper 4 and the gripper holder 7. The restoring elements 12 used are compression springs.

The gripping device 3 additionally comprises a body illumination unit 13 which is used together with a gripping point determination unit 14 and a controller 15 for gripping point determination or identification of gripping points accessible for the gripper 4. The body illumination unit 13 serves to illuminate a depositing surface 22 on which the toothbrush bodies 2 are deposited with such brightness that identification of accessible gripping points is reliably possible by means of cameras 16 of the gripping point determination unit 14. The gripper 4 is additionally equipped with two sensors 17 which are designed to check the presence of a gripped body 2 between the gripper jaws 9 of the gripper 4.

The stripping elements 6 of the stripper 5 are arranged on different sides of the gripper 4. In their starting position according to FIG. 2, the stripping elements 6 of the stripper 5 cross one another in pairs. The four stripping elements 6 in total of the gripper 4 shown in the figures are arranged spaced apart from one another in pairs, with the thus formed two pairs of stripping elements 6 being arranged on the gripper holder 7 so as to be movable in pairs about the already aforementioned common pivot axis. The stripping elements 6 of a pair can thus be pivoted jointly about the same pivot axis from their starting position into their end position. Here, the movement occurs from an inward to outward direction. The pivot axes of the stripping elements 6 are, as has already been mentioned above, parallel to and at a distance from one another.

A distance between the stripping elements 6 of each pair is here greater than a dimension of the gripper 4 that can be measured in the distance direction. It is possible in this way for the stripping elements 6 to pivot past the gripper 4.

If the stripping elements 6 are situated in their starting position shown in FIG. 2, they are arranged completely between a cross-sectional plane of the gripper 4 extending through a free end and the gripper holder 7. The same applies if the stripping elements 6 have attained their end position shown in FIG. 6. It is thus ensured that the stripping elements 6 are not in the way in the starting position and in the end position and do not hamper pick-up or deposition of the gripped bodies 2.

In an intermediate position, which is shown for example in FIG. 4, the stripping elements 6 are arranged in such a way that their distal ends project through the aforementioned, imaginary cross-sectional plane. This means in other words that, in this intermediate position, the stripping elements 6 project beyond the free end of the gripper 4.

The aforementioned positioning stops 8 of the gripper 4 are arranged or formed between the gripper jaws 9 of the gripper 4 and additionally on the gripper 4 itself. The gripping device 3 additionally has a robot arm 18. The gripper 4 is arranged on this robot arm 18.

The separating device 1 additionally has a body-feeding device 19. The body-feeding device 19 comprises a chute 20 and a distributing belt 21 downstream of the chute 20. On both sides of the distributing belt 21 there are arranged depositing surfaces 22 on which bodies 2, here toothbrush bodies 2, fed via the body-feeding device 19 of the separating device 1 at first come to lie in an unordered manner. The bodies 2 lying thereon in an unordered manner are finally gripped by means of the gripping device 3 described in detail above, separated as a result and transported further. The distributing belt 21 is assigned a body sensor 32 which can be used to determine a number of brush bodies 2 on the distributing belt 21. It is thus possible to stop the feed of brush bodies 2 via the chute 20 if a sufficient number of brush bodies 2 is arranged on the distributing belt 21. The body sensor 32 used in each of the separating devices 1 shown is a weight detector. In principle, it is also possible to optically determine the number of the bodies 2 on the distributing belt 21 by a camera.

The aforementioned depositing surfaces 22 are formed on troughs 23 of the separating device 1. The separating device 1 further comprises a vibrating device 24. The vibrating device 24 serves to at least coarsely part bodies 2 lying on the depositing surfaces 22 of the troughs 23 in order to allow the identification of accessible gripping points. For this purpose, the vibrating device 24 has two vibrating belts 25 which form part of the depositing surfaces 22 within the troughs 23. The vibrating belts 25 make it possible for the position of the bodies 2 lying on the vibrating belts 25 to be changed by a corresponding movement.

The vibrating device 24 additionally comprises two vibrating tables 26 on which the aforementioned troughs 23 are arranged. Activating the vibrating tables 26 allows the troughs to be caused to move or vibrate in order to change the position of bodies 2 arranged therein as required. The use of the vibrating tables 26 also ultimately serves to change the position of the bodies 2 in such a way that an accessible gripping point for the gripper 4 of the gripping device 3 can be identified at least in one body 2.

In the separating device 1 shown in the figures, the aforementioned body illumination unit 13 of the gripping device 3 is, just like the two cameras 16, arranged above the depositing surfaces 22 and the troughs 23 of the separating device 1. The body illumination unit 13 is illustrated only in a highly schematic manner in the figures and can, for example, be integrated into the cameras 16.

The separating device 1 has a depositing station 27 downstream of the gripping device 3. Defined body depositing places 28 are formed at the depositing station 27. The body depositing places 28 are arranged on a depositing belt 29 of the depositing station 27. It is possible by means of the depositing belt 29 for the body depositing places 28 and separated bodies 2 arranged thereon to be fed to a handling unit 30 of the separating device 1 that is assigned to the depositing station 27. The handling unit 30 makes it possible for the separated bodies 2 to be removed from the body depositing places 28 on the depositing belt 29 of the depositing station 27 and to be fed to further processing stations (not illustrated in more detail in the figures) which, in the application shown, are brush-processing stations.

The method described below for gripping provided bodies 2 can be carried out by the above-described separating device 1 and the above-described gripping device 3.

Here, a gripping point of a body 2 that is accessible for the gripper 4 is first identified. The gripper 4 then grips the body 2 at the identified gripping point. The stripper 5 assigned to the gripper 4 is then activated, and the stripping elements 6 are moved past the gripper 4 in the stripping movement between the starting position and the end position. The aim of this is to remove bodies 2 bearing against the gripped body 2 and/or lying on the gripped body 2 and/or colliding therewith from the gripper 4 and thus ultimately also from the gripped body 2.

As illustrated in the figures, the bodies 2 are here elongate bodies, namely toothbrush bodies 2. The bodies 2 to be gripped are provided in the form of loose material.

The accessible gripping point is optically identified by means of the aforementioned cameras 16. Particularly when no accessible, that is to say free, gripping point can be identified, the bodies 2 to be gripped are loosened or separated on the depositing surface 22. This occurs by means of the aforementioned vibrating device 24 of the separating device 1.

It can be checked as required whether a body 2 has been gripped by the gripper 4 of the gripping device 3. For this purpose, the sensors 17 of the gripping device 3 which are provided therefor can be used. If required, it can also be concluded whether a body 2 has actually been gripped or not by determining a length of a closing movement of the gripper 4.

A monitoring sensor 31, which is a force sensor 31 in the exemplary embodiments shown of the gripping device 3, can be used to monitor an approach movement of the gripper 4 into its gripping position. This occurs by monitoring a driving force of a drive of the corresponding gripper 4. If the gripper 4 is lowered into its gripping position and if at the same time an inadmissible increase in force at the drive of the gripper 4 is detected by the force sensor 31, the drive can be deactivated and the gripper 4 halted to avoid damage to the gripper 4 and/or to bodies 2 to be gripped. It is also possible to monitor the gripper movement by software and/or by the controller 15 already mentioned above. Thus, it is possible to monitor for example a power consumption of a drive by which the gripper 4 is moved into its gripping position. If an inadmissible increase in the power consumption is detected, this in turn can be attributed to a collision or an obstacle in the way of the gripper 4. In this case, too, the gripper 4 can be halted for safety reasons.

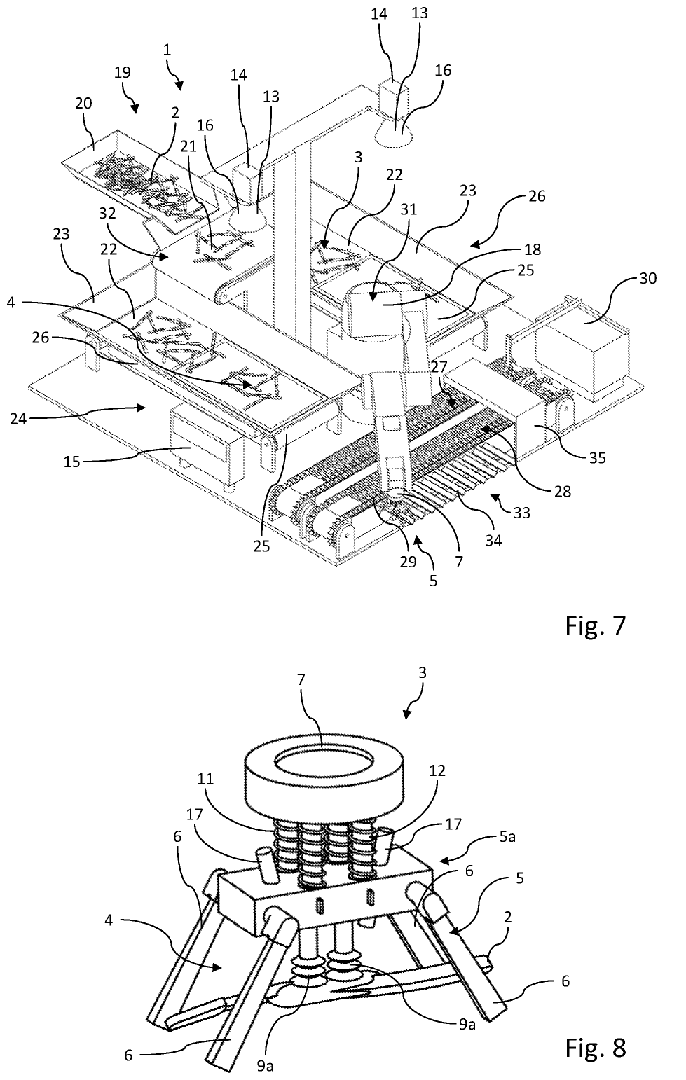

FIGS. 7 and 8 show a slightly modified embodiment of the separating device 1 illustrated in the other figures. The gripper 4 of the gripping device 3 of this separating device 1 is designed as a suction gripper. FIG. 8 illustrates that, instead of gripper jaws, the suction gripper 4 has two suckers 9a by which bodies 2, here a toothbrush body 2, can be sucked on by means of negative pressure and thus gripped.

The separating device shown in FIG. 7 additionally has a buffer device 33. Pockets 34 for bodies 2 are provided in the buffer device 33. The pockets 34 are V-shaped in form. The V-shaped pockets 34 serve for centring and/or properly orienting bodies 2. The pockets 34 of the buffer device 33 can be filled by means of the gripping device 3.

It is then possible by a transfer device 35 for the bodies 2 properly oriented on the pockets 34 of the buffer device 33 to be deposited onto the body depositing places 28 of the depositing belt 29 of the depositing station 27.

It is possible by use of the transfer device 35 for bodies 2 situated on the body depositing places 28 of the depositing belt 29 of the depositing station 27 to be fed to the buffer device 33 in order to correct an improper orientation of bodies 2 by means of the V-shaped pockets 34 of the buffer device 33. The bodies 2 can then be fed again to the depositing station 27 by means of the transfer device 35.

Furthermore, it is possible to fill unoccupied body depositing places 28 of the depositing belt 29 with bodies 2 from the buffer device 33. For this purpose, the bodies 2 can be removed by means of the transfer device 35 from the buffer device 33 and fed to the body depositing places 28.

As has already been explained above, the gripping devices 3 described in detail can be used in particular for gripping elongate bodies 2, namely for example for gripping toothbrush bodies 2.

The invention is concerned with improvements in the technical field of handling blanks, semi-finished products or finished products in preferably automated production processes. What is provided for this purpose is, inter alia, the gripping device 3 which has the gripper 4. The gripper 4 is assigned the stripper 5 of the gripping device 3, said stripper having at least one stripping element 6. The stripping element 6 can be moved as required past the gripper 4 in a stripping movement between a starting position and an end position in order to remove bodies 2 possibly interfering with the gripping process from a gripping region of the gripper 4. This occurs in particular when the gripper 4 has already gripped a body 2.

### LIST OF REFERENCE SIGNS

1 Separating device
2 Body, toothbrush body
3 Gripping device
4 Gripper
5 Stripper
5a Stripper drive
6 Stripping element
7 Gripper holder
8 Positioning stop
9 Gripper jaws
9a Sucker
10 Centring means, cut-outs
11 Guide element
12 Restoring element
13 Body illumination unit
14 Gripping point determination unit
15 Controller
16 Camera
17 Sensor
18 Robot arm
19 Body-feeding device
20 Chute
21 Distributing belt
22 Depositing surface
23 Trough
24 Vibrating device
25 Vibrating belt
26 Vibrating table
27 Depositing station
28 Body depositing places
29 Depositing belt
30 Handling unit
31 Monitoring sensor/force sensor
32 Body sensor/weigher
33 Buffer device
34 V-shaped pockets
35 Transfer device

1. A gripping device (3) comprising:
at least one gripper (4) for gripping provided bodies (2);
at least one stripper (5) assigned to the gripper (4), the at least one stripper including at least one stripping element (6);
the stripping element (6) is movable past the gripper (4) in a stripping movement between a starting position and an end position in order to remove bodies (2) that are at least one of bearing against the gripped body (2), lying on the gripped body (2), or colliding therewith from at least one of the gripper (4) or the gripped body (2).

2. The gripping device (3) according to claim 1, further comprising a stripper drive (5a) for driving the at least one stripping element (6), or the at least one stripping element (6) being pivotably mounted with a pivot axis of the stripping element (6) being oriented in or parallel to a closing direction of the gripper (4).

3. The gripping device (3), according to claim 1, wherein the at least one gripper (4) for gripping provided bodies is arranged on a gripper holder (7) of the gripping device (3) and is mounted resiliently.

4. The gripping device (3) according to claim 1, further comprising at least one positioning stop (8) which is configured to define on the gripper (4) a desired position of a body (2) to be gripped.

5. The gripping device (3) according to claim 1, wherein the gripper (4) includes gripping jaws (9), at least one of the gripper jaws (9) having at least one centring device (10) formed as at least one cut-out (10), and the centring device (10) configured to define a position of one of the bodies (2) relative to the gripper jaws (9).

6. The gripping device (3) according to claim 5, wherein the gripper jaws (9) of the gripper (4) are 3D-printed.

7. The gripping device (3) according to claim 1, wherein the at least one gripper (4) is a suction gripper.

8. The gripping device (3) according to claim 3, further comprising at least one guide element (11) and at least one restoring element (12) which are arranged between the gripper (4) and the gripper holder (7) for resilient mounting of the at least one gripper (4).

9. The gripping device (3) according to claim 1, further comprising at least one of a monitoring sensor (31) or software for monitoring at least one of an approach movement of the at least one gripper (4) into a gripping position or a driving force of a drive of the at least one gripper (4).

10. The gripping device (3) according to claim 1, further comprising at least one of a body illumination unit (13), a gripping point determination unit (14), a controller (15), or a sensor (17) for checking a presence of a gripped one of the bodies (2).

11. The gripping device (3) according to claim 1, wherein the stripper (5) has at least two of the stripping elements (6) which are arranged on different sides of the gripper (4), the stripping elements (6) cross one another in a starting position, or the stripper (5) comprises two pairs of spaced-apart, movably mounted ones of the stripping elements (6), and a distance between the stripping elements (6) of a first one of the pairs is greater than a dimension of the gripper (4) measured in a distance direction.

12. The gripping device (3) according to claim 1, wherein in at least one of the starting position or the end position, the at least one stripping element (6) is arranged between a cross-sectional plane of the gripper (4), which extends through a free end, and a gripper holder (7), and with the stripping element (6) situated in an intermediate position, a distal end of the at least one stripping element (6) is arranged beyond the cross-sectional plane, starting from the free end of the gripper (4).

13. The gripping device (3) according to claim 1, further comprising a positioning stop (8) arranged or formed on or between gripper jaws (9) of the gripper (4).

14. The gripping device (3) according to claim 1, further comprising at least one robot arm (18) on which the gripper (4) is arranged.

15. A separating device (1) comprising a gripping device (3) according to claim 1.

16. The separating device (1) according to claim 15, further comprising at least one of a body-feeding device (19), at least one depositing surface (22) for bodies (2) to be at least one of separated or to be gripped, or a vibrating device (24) for separating bodies (2) to be gripped.

17. The separating device (1) according to claim 16, further comprising at least one of a body illumination unit (13) arranged below the depositing surface (22), or a body illumination unit (13) arranged above the depositing surface (22).

18. The separating device (1) according to claim 15, further comprising a depositing station (27) downstream of the gripping device (3) with defined body depositing places (28), a handling unit (30) assigned to the depositing station (27) for further transporting the separated bodies (2).

19. A method for gripping provided bodies (2) using a gripping device (3), the method comprising:
identifying a gripping point of a body (2) that is accessible for a gripper (4) of the gripping device (3),
gripping the body by the gripper (4) at the identified gripping point;
moving at least one stripping element (6) of a stripper (5) assigned to the gripper (4) past the gripper (4) in a stripping movement between a starting position and an end position thereby removing the bodies (2) that are at least one of bearing against the gripped body (2), lying on the gripped body (2), or colliding therewith from at least one of the gripper (4) or the gripped body (2).

20. The method according to claim 19, wherein at least one of: the bodies (2) to be gripped are elongate bodies (2), or the bodies (2) to be gripped are provided as loose material.

21. The method according to claim 19, wherein at least one of: the gripping point is identified optically, or the bodies (2) to be gripped are pre-separated using a vibrating device (24).

22. The method according to claim 19, further comprising checking whether one of the bodies (2) has been gripped by at least one of using a sensor (17) or determining a length of a closing movement of the gripper (4).

23. The method of claim 19, wherein the elongate bodies (2) that are gripped are at least one of brush bodies or toothbrush bodies (2).
